(19) United States
(12) Patent Application Publication
(10) Pub. No.: US 2017/0262398 A1
(43) Pub. Date: Sep. 14, 2017

(54) Power Efficient Distributed Beam Forming Architecture Using Interconnected Processing Nodes

(71) Applicant: L3 Technologies Inc., New York, NY (US)

(72) Inventors: Cesar Armando LUGO, Dallas, TX (US); Heath KEENE, Plano, TX (US); Brian Joseph KIEDINGER, Plano, TX (US)

(73) Assignee: L3 Technologies Inc., New York, NY (US)

(21) Appl. No.: 15/449,220

(22) Filed: Mar. 3, 2017

Related U.S. Application Data
(60) Provisional application No. 62/305,405, filed on Mar. 8, 2016.

(51) Int. Cl. G06F 13/42; H04B 7/06

(52) U.S. Cl. CPC G06F 13/4221; H04B 7/0617; G06F 13/4282

(57) ABSTRACT

A digital beamforming apparatus for use in a radar system. The digital beamforming apparatus comprises i) a plurality of multichip modules, each of the multichip modules comprising a plurality of application specific integrated circuit (ASIC) devices; ii) at least a first serial bus configured to couple a first multichip module to an antenna element; and iii) at least a second serial bus configured to couple the first multichip module to a second multichip module, wherein a first ASIC device on the first multichip module is coupled to a second ASIC device on the first multichip module by means of a first parallel bus. The first and second ASIC devices perform beamforming operations. The first ASIC device outputs beamforming data to the second ASIC device on the first parallel bus.

### CROSS-REFERENCE TO RELATED APPLICATION(S) AND CLAIM OF PRIORITY

The present application is related to U.S. Provisional Patent No. 62/305,405, filed Mar. 8, 2016, entitled “POWER EFFICIENT DISTRIBUTED BEAM FORMING ARCHITECTURE USING INTERCONNECTED PROCESSING NODES”. Provisional Patent No. 62/305,405 is assigned to the assignee of the present application and is hereby incorporated by reference into the present application as if fully set forth herein. The present application hereby claims priority under 35 U.S.C. §119(e) to U.S. Provisional Patent No. 62/305,405.

### TECHNICAL FIELD

The present application relates generally to a digital aperture processing back-end architecture that interconnects smaller and less complex data processing nodes to reduce power consumption and allow continued operation when elements fail.

### BACKGROUND

Radio frequency (RF) sensors (e.g., radar) use an array of antenna elements whose outputs are combined with an analog summer (i.e., an analog beam former) to electronically scan one transmit beam or receive beam in the desired spatial direction. However, analog beam forming limits operation to a single beam at a time. The next generation of RF sensors (i.e., digital aperture devices) digitize every antenna element and combine the antenna outputs digitally using a single processing node or multiple processing nodes. Digital combination of data (i.e., digital beam forming) allows the formation of multiple simultaneous receive beams. These beams can be pointed simultaneously to several different locations in space. This significantly increases the capability of a sensor.

However, digitizing every antenna element in an antenna array and forming multiple simultaneous beams produces large amounts of data. To handle this large data volume, digital beam-forming architectures use large, complex, and expensive application specific integrated circuits (ASICs) or field programmable gate arrays (FPGAs) that present large size, weight and power (SWAP) challenges. Significantly, this limits the use of element level digital apertures to large platforms, such as ships or ground based platforms, that can support a large SWAP installation.

Thus, the problems of large power consumption and large size of the current digital beam-forming architectures have limited the applications for digital aperture systems. Applications that need low SWAP and low power consumption, including but not limited to, airborne systems, unmanned aerial vehicles (UAVs), 5G communications, and the like, continue to wait for a smaller, lower power system architecture to implement fully elemental digital beam forming. Current solutions reduce performance by reducing the bandwidth of operation and limit the use of digital arrays to platforms that can sustain large SWAP installations. This severely reduces the number of beams and reduces flexibility of where the beams can be pointed.

Therefore, there is a need in the art for an improved beam-forming apparatus for use in radar systems. In particular, there is a need for a digital aperture system that does not require a large SWAP architecture.

### SUMMARY

To address the above-discussed deficiencies of the prior art, it is a primary object to provide, for use in a radar system, a digital beamforming apparatus comprising: i) a plurality of multichip modules, each of the multichip modules comprising a plurality of application specific integrated circuit (ASIC) devices; ii) at least a first serial bus configured to couple a first multichip module to an antenna element; and iii) at least a second serial bus configured to couple the first multichip module to a second multichip module, wherein a first ASIC device on the first multichip module is coupled to a second ASIC device on the first multichip module by means of a first parallel bus.

In one embodiment, the first and second ASIC devices perform beamforming operations.

In another embodiment, the first ASIC device outputs beamforming data to the second ASIC device on the first parallel bus.

In still another embodiment, each of the plurality of multichip modules comprises a silicon interposer on which the plurality of ASIC devices is configured.

In yet another embodiment, the first parallel bus is implemented in a silicon interposer associated with the first multichip module.

In a further embodiment, the first parallel bus comprises a copper pillar in the silicon interposer associated with the first multichip module.

In a still further embodiment, the digital beamforming apparatus further comprises at least a third serial bus configured to couple the second multichip module to a signal processor at the output of the digital beamforming apparatus.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a conventional analog beam-forming apparatus according to one embodiment of the prior art.

FIG. 2 illustrates a digital beam-forming apparatus according to one embodiment of the disclosure.

FIG. 3 illustrates a top view of an exemplary digital architecture for efficient beam-forming according to one embodiment of the disclosure.

FIG. 4 illustrates a side view of an exemplary digital architecture for efficient beam-forming according to one embodiment of the disclosure.

### DETAILED DESCRIPTION

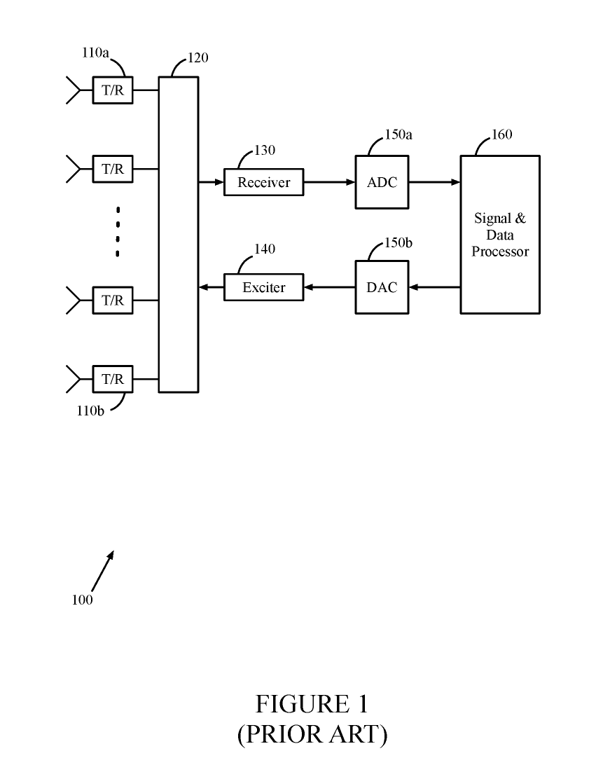

FIGS. 1 through 4, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged digital beam-forming architecture.

FIG. 1 illustrates analog radar system 100 according to one embodiment of the prior art. Analog radar system 100 comprises a plurality of radio frequency (RF) front-end transceiver (T/R) circuit blocks 110, including exemplary T/R circuit blocks 110a and 110b, analog beamformer 120, receiver path circuitry 130, exciter path circuitry 140, analog-to-digital converter (ADC) 150a, digital-to-analog converter (DAC) 150b, and signal and data processor 160. Each of T/R circuit blocks 110 is coupled to an antenna element of an antenna array and comprises switching circuitry for transmission mode and receive mode.

In the radar transmit path, signal and data processor 160 sends digital transmit data to DAC 150b, which converts the transmit data to analog format. Exciter 140 comprises frequency synthesizer circuitry and up-converter circuitry that produce a radio frequency (RF) output. Analog beamformer 120 splits the RF output of exciter 140 into multiple transmit path signals, and applies amplitude and/or phase changes in each of the transmit path signals going to the plurality of T/R circuit blocks 110 that drive an antenna element. The result is a single antenna beam formed by analog radar system 100.

In the radar receive path, multiple incoming RF signals from the plurality of T/R circuit blocks 110 are applied to analog beamformer 120, which applies complex weights to the RF signals from each antenna in the array. The complex weights consist of both amplitude and phase components. Analog beamformer 120 comprises a summation network circuit that combines the weighted signals from all the antenna elements into a single analog output signal that is sent to receiver path circuitry 130 for further processing (i.e., filtering, down-conversion, etc.). The analog baseband (or IF) output from receiver path circuitry 130 is then converted to a digital signal by ADC 150a. The digitized output of ADC 150a is finally sent to signal and data processor 160.

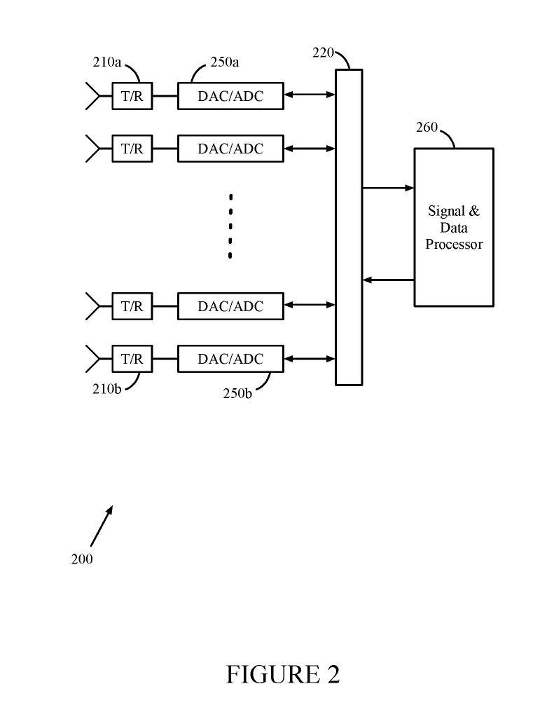

FIG. 2 illustrates digital radar system 200 according to one embodiment of the disclosure. Digital radar system 200 comprises a plurality of radio frequency (RF) front-end transceiver (T/R) circuit blocks 210, including exemplary T/R circuit blocks 210a and 210b, digital converter blocks 250, including exemplary digital converter blocks 250a and 250b, digital beamformer 220, and signal and data processor 260. Digital converter blocks 210 comprise the necessary digital-to-analog converter (DAC) circuits and analog-to-digital converter (ADC) circuits to converter data between the analog and digital domains.

In both the transmit and receive modes, the RF signals to and from every antenna element connected to T/R circuit blocks 210 is digitized, resulting in multiple simultaneous transmit and receive beams that are processed by digital beamformer 220 and signal and data processor 260. Digitizing data in every antenna element in an array results in an enormous amount of data, high heat dissipation, high power consumption, large size and weight, and requires large ASICs or FPGAs to process the data.

The present disclosure reduces the size, weight and power (SWAP) requirements of digital beamformer 220 by combining three improvements for efficient beamforming. These three improvements include: 1) the use of smaller processing nodes (i.e., ASICs) that service a small number of dual polarized antenna elements; 2) forming multichip modules (MCMs) by using copper pillars in parallel connections between adjacent ASICs; and 3) implementing a redundant data interconnect architecture for connecting multiple MCMs.

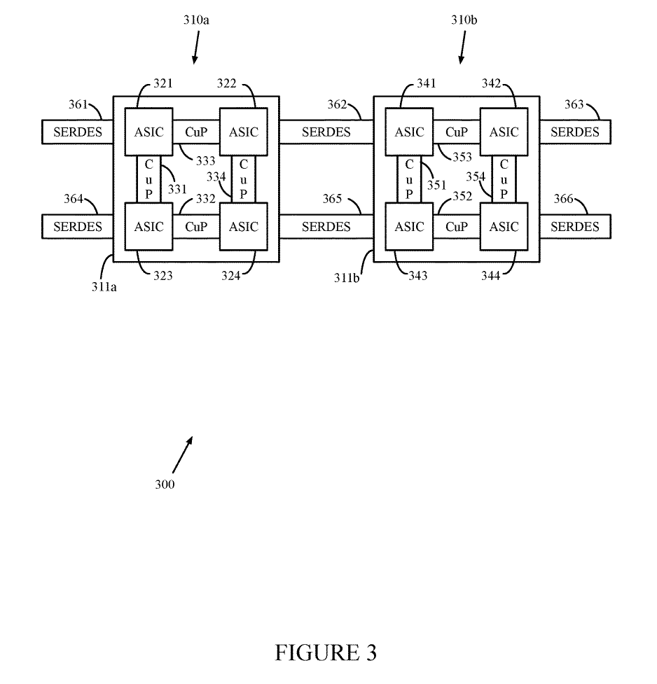

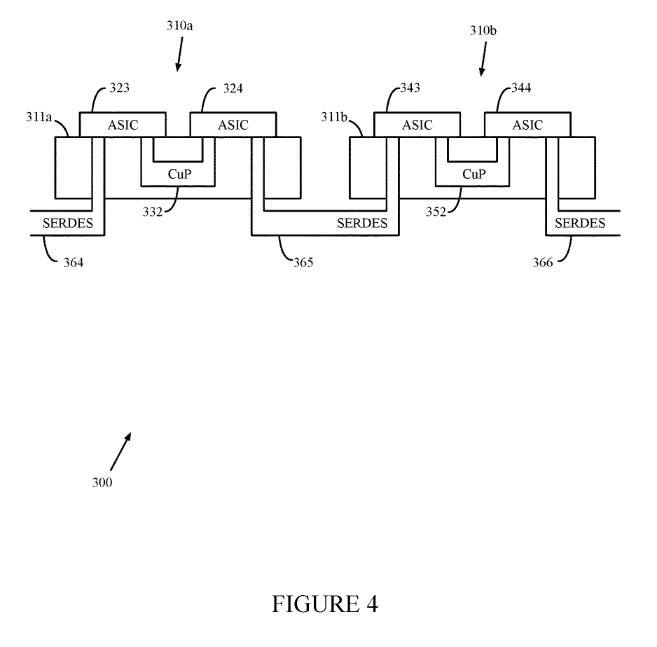

FIG. 3 illustrates an exemplary digital architecture 300 for efficient beam-forming according to one embodiment of the disclosure. FIG. 4 illustrates a cross-sectional view of exemplary digital architecture 300 for efficient beam-forming according to one embodiment of the disclosure. Exemplary digital architecture 300 may optimally be implemented in digital beamformer 220 shown in FIG. 2.

Digital architecture 300 includes a plurality of multichip modules (MCMs) 310, including exemplary MCMs 310a and 310b. The multichip modules are coupled to each other and to T/R circuit blocks 210, digital converter blocks 250, and signal and data processor 260 by means of serializer-deserializer (SERDES) interfaces 361-366. In this manner, each MCM 310 receives incoming data in serial format and converts the received data to parallel format for internal processing within MCM 310. At the output of each MCM 310, the processed parallel data is converted back to serial format for transmission to, for example, another MCM 310 or signal and data processor 260.

The exemplary multichip module (MCM) 310a comprises a plurality of application specific integrated circuit (ASIC) devices 321-324 that are configured on silicon interposer 311a and coupled to each other by means of a plurality of copper pillar (CuP) parallel connection buses 331-334 within silicon interposer 311a. Similarly, multichip module (MCM) 310b comprises a plurality of application specific integrated circuit (ASIC) devices 341-344 that are configured on silicon interposer 311b and coupled to each other by means of a plurality of copper pillar (CuP) parallel connection buses 351-354 within silicon interposer 311b. Additional MCMs 310 (not shown) may be implemented in digital beamformer 220 depending on the size and performance requirements of the digital radar system 200. It will be understood by those skilled in the art that ASIC devices may instead be field programmable gate array (FPGA) devices without departing from the scope of the present disclosure.

The cross-sectional view in FIG. 4 passes through SERDES interfaces 364-366, ASIC devices 323-324 and 343-344, CuP parallel connection buses 332 and 352, and silicon interposers 311a and 311b. Each of ASIC devices 321-324 and ASIC devices 341-344 comprises a digital beamforming ASIC. Each ASIC device forms beams digitally using the data sampled from the local antenna element(s) that the ASIC device is servicing. The number of antenna elements serviced by each ASIC device is kept to a low number. Within each MCM 310, each copper pillar (CuP) parallel connection bus is used to transfer digital beamformed data from one ASIC device to a nearby ASIC device in a parallel format through the corresponding silicon interposer 311.

ASIC devices 321-324 and 341-344 generates the digital beamformed data by applying steering weights to the I/Q samples of multiple receiver (RX) channels and adding the results to form beams in a particular direction. These steering weights may comprise complex phasors with amplitude and a phase progression. Alternatively, steering weights may be implemented through true time delays (TTDs) using methods such as digital fractional delay filters. The transfer of beamformed data in parallel format between ASIC devices greatly improves the performance of digital beamformer 220.

In sum, the present disclosure combines three concepts for efficient digital beamforming. First, the improved digital beamformer uses smaller processing nodes that convention digital beam formers. Second, the improved digital beamformer uses copper pillar CuP parallel connection buses for nearby ASICs for form the MCMs. Finally, the improved digital beamformer makes a redundant data interconnect architecture for connection amongst MCMs.

The improved digital beamforming architecture provides reduced data processing throughput by forming beams within each ASIC device and reducing the amount of data that is passed around within the digital beamforming architecture. The improved digital beamforming architecture also provides reduced power consumption at the ASIC level since the ASIC devices are smaller and services fewer antenna elements. Power is further reduced at the system level by replacing power hungry SERDES serial connection interfaces between ASICs with more power efficient parallel CuP buses for connections of nearby ASICs.

The improved digital beamforming architecture requires fewer hardware components since no additional hardware nodes are needed for beam forming. The ASIC devices that sample the digital data also do the beamforming in a distributed fashion. By using smaller processing nodes and having redundant connections, the improved digital beamforming architecture reduces the impact of ASIC failures in the system.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A digital beamforming apparatus comprising:
a plurality of multichip modules, each of the multichip modules comprising a plurality of application specific integrated circuit (ASIC) devices;
at least a first serial bus configured to couple a first multichip module to an antenna element; and
at least a second serial bus configured to couple the first multichip module to a second multichip module,
wherein a first ASIC device on the first multichip module is coupled to a second ASIC device on the first multichip module by means of a first parallel bus.

2. The digital beamforming apparatus as set forth in claim 1, wherein the first and second ASIC devices perform beamforming operations.

3. The digital beamforming apparatus as set forth in claim 2, wherein the first ASIC device outputs beamforming data to the second ASIC device on the first parallel bus.

4. The digital beamforming apparatus as set forth in claim 3, wherein each of the plurality of multichip modules comprises a silicon interposer on which the plurality of ASIC devices is configured.

5. The digital beamforming apparatus as set forth in claim 4, wherein the first parallel bus is implemented in a silicon interposer associated with the first multichip module.

6. The digital beamforming apparatus as set forth in claim 5, wherein the first parallel bus comprises a copper pillar in the silicon interposer associated with the first multichip module.

7. The digital beamforming apparatus as set forth in claim 4, further comprising at least a third serial bus configured to couple the second multichip module to a signal processor at the output of the digital beamforming apparatus.
